(19) United States
(12) Patent Application Publication
(10) Pub. No.: US 2015/0265101 A1
(43) Pub. Date: Sep. 24, 2015

(54) SERVING WARE COVERING APPARATUS

(71) Applicant: Shawna Cannon Lemon, Morrisville, NC (US)

(72) Inventor: Shawna Cannon Lemon, Morrisville, NC (US)

(21) Appl. No.: 14/222,718

(22) Filed: Mar. 24, 2014

(51) Int. Cl. A47J 41/00

(52) U.S. Cl. CPC A47J 41/0061

(57) ABSTRACT

A protective covering for serving ware. The covering can be secured around the perimeter of the serving ware and can be secured by any means suitable to fasten one end of the covering to an opposite end of the covering. The serving ware may be in the form of a tray or dish. The protective covering can be configured to conform to the shape of the serving ware. The covering may be loosely or tightly conformed to the shape of the serving ware. The covering may be decorative and may include a thermal insulating layer to create a barrier between the serving ware and the server's hand(s).

### FIELD

The present disclosure relates to the field of kitchen products, in particular, a removable covering for serving ware and cookware.

### BACKGROUND

Insulated pads have been used in the serving of casserole dishes or cookware, (oven heated or refrigerated). The pads are generally square or round, and include some type of an insulation material. Additionally cooks have used insulated gloves such as oven mitts. These mats and gloves are wrapped around the edge of a casserole to hold it when removing it from the oven and carrying it to the table.

When the hot casserole is placed on the table, it is normally desirable to have some type of insulated material between the casserole and the table to prevent burning and discoloration of the table surface. This is accomplished with trivets of various types which hold the casserole above the table, thereby allowing the hot dish to be readily accessible but out of direct contact with the table. While trivets are generally constructed from rigid materials, there are also fabric receptacles adapted to receive dishes. These receptacles sit directly on the table, separating the casserole from the table by the fabric material.

During holidays or other occasions, decorative serving trays or dish holders are often used to decorate a dish for table service. These solutions either require the user to transfer the food into the decorative tray or dish, or place the pan or dish into the decorative holder. Prior art solutions fail to provide for a covering that can attach directly to cookware or serving ware for use as a heat barrier and decorative covering.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

An object of the present disclosure is an apparatus comprising a fabric layer, the fabric layer having a first surface configured to engage with an upper perimeter of a serving ware, and a second surface coupled to the first surface, the second surface extending downward substantially perpendicularly from the first surface; a coupling means connected to the fabric layer and configured to engage the first surface with the upper perimeter of the serving ware; and, an insulating layer disposed on the fabric layer, the insulating layer being disposed on an interior portion of the fabric layer when engaged to the upper perimeter of the serving ware.

Another object of the present disclosure is an apparatus comprising a protective surface selectively disposed upon a serving ware, the protective surface having a first side and a second side, the first side extending from an upper perimeter of the serving ware and draping downward from the upper perimeter and terminating substantially perpendicularly to the upper perimeter of the serving ware, and the second side being in contact with an upper perimeter portion of the serving ware when selectively disposed upon the serving ware; and, a coupling means connected to the protective surface, the coupling means configured to selectively couple the protective surface to the serving ware.

Yet another object of the present disclosure is an apparatus comprising a heat insulating surface selectively coupled to a serving ware, the heat insulating surface having a grip portion and a base portion, the grip portion being selectively coupled to an upper perimeter of the serving ware, and the base portion selectively engaged with a bottom surface and a side surface of the serving ware and coupled to the grip portion; and, a coupling means connected to the heat insulating surface, the coupling means configured to selectively couple a first end of the heat insulating surface to a second end of the heat insulating surface such that the grip portion and the base portion are sizably connected.

The foregoing has outlined rather broadly the more pertinent and important features of the present invention so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present invention. It should be realized by those skilled in the art that such equivalent structures do not depart from the spirit and scope of the invention as set forth in the appended claims.

### BRIEF DESCRIPTION OF DRAWINGS

The above and other objects, features and advantages of the present disclosure will be more apparent from the following detailed description taken in conjunction with the accompanying drawings, in which:

FIG. 1 is a perspective view of a serving ware covering apparatus according to an embodiment.

FIG. 2 is a perspective view of a serving ware covering apparatus according to an embodiment.

FIG. 3 is a perspective view of a serving ware covering apparatus according to an embodiment.

### DETAILED DESCRIPTION

Exemplary embodiments are described herein to provide a detailed description of the present disclosure. Variations of these embodiments will be apparent to those of skill in the art. Moreover, certain terminology is used in the following description for convenience only and is not limiting. For example, the words “right,” “left,” “top,” “bottom,” “upper,” “lower,” “inner” and “outer” designate directions in the drawings to which reference is made. The word “a” is defined to mean “at least one.” The terminology includes the words above specifically mentioned, derivatives thereof, and words of similar import.

The present disclosure relates to a protective and/or decorative covering for serving ware, such as cookware, and includes a serving tray, serving dish or casserole dish. In particular, oven-to-table, stovetop-to-table and/or grill-to-table cookware have become a convenient way to cook and serve warm food to guests. The cookware may be suitable for a stovetop, grill or oven including a conventional oven, convection oven, ceramic oven, masonry oven, tandoor oven, toaster oven or microwave oven. The cookware may be disposable cookware. The disposable cookware may be composed of such material as aluminum, paper, foil or plastic, or a combination thereof. Alternatively, the cookware may be non-disposable cookware. The non-disposable cookware may be made from materials such as stoneware, ceramic, clay, cast aluminum, china, porcelain, glass or cast iron, or a combination thereof. In any event, once removed from the cooking apparatus, the cookware is generally hot and can cause injury if touched immediately and/or for a significant time afterwards. However, a purpose of the cook direct-to-table aspect of the cookware is to allow the server to place the cookware on a table or serving area so that guests can serve or be served warm food.

Embodiments of the present disclosure allow the placement of the cookware from the cooking area to the table or serving area by providing a protective and/or decorative covering for the cookware that has been recently removed from the cooking area. In some embodiments, the covering is protective in that the covering serves as a barrier to prevent burns resulting from touching the cookware directly or indirectly while the cookware is on the table or serving area. In some embodiments, however, the serving ware may be cold. If the serving ware is cold, the protective covering may protect the server from exposure to a colder temperature that may result from touching the serving ware that may have been refrigerated or exposed to colder temperatures.

In some embodiments, the protective covering is decorative and adds to the decoration and/or ambiance of the occasion for which the food is being served.

The protective covering may be composed of a material including fabric, metal, glass, ceramic, willow, bamboo, copper, stone, tile, jewels, crystals, wood, shells, beads or leather (faux or natural), or combinations thereof. Fabric employed may be a fabric to suit the occasion. For example, the fabric may be a themed fabric, which correlates to a holiday such as Thanksgiving, Hanukah, Christmas, Valentine's Day, Easter, Independence Day; special occasions such as birthdays, graduations, bar mitzvahs, bat mitzvahs, weddings, bridal showers, baby showers; elegant occasions such as dinner parties, receptions, brunches and luncheons; and/or more casual occasions such as picnics or typical family dinners. Thus, the fabric may be decorative or plain and may include, cotton, polyester, linen, silk, rayon, satin, canvas, hemp, wool, muslin, acetate, nylon and spandex. The fabric may be treated to render the fabric heat resistant and/or stain resistant. The fabric may be lined with an additional material such as those listed above or with a quilted heavy weight cotton, thick cotton terry, cotton batting, silicone, or neoprene material.

The protective covering may be a suitable desirable or decorative fabric or material on the outside facing away from the serving ware. The protective covering may be a quilted heavy weight cotton, thick cotton terry, cotton batting, silicone, or neoprene material on the inside facing toward the serving ware. Alternatively, the quilted heavy weight cotton, thick cotton terry, cotton batting, silicone, or neoprene material may comprise an inner area between two fabric sides that cover the perimeter of the serving ware. In some embodiments, the protective covering protects an individual from a significant burn injury or exposure to cold temperatures. In some embodiments, the protective covering is heat resistant and/or stain resistant.

In particular embodiments, the covering is secured around the perimeter of the serving ware. The covering can be secured by any means suitable to fasten one end of the covering to an opposite end of the covering such as ties, hook and loop fasteners (such as Velcro), snaps, hooks, buttons, magnetic closure, elastic, and the like. In some embodiments, the covering may fit around the perimeter of the serving ware by means of elastic closure incorporated into the covering. In some embodiments, the covering fits around the perimeter and bottom of the serving ware. The serving ware may be in the form of a tray or dish. The serving ware may further be in the shape of a rectangular, oblong, square, round, oval or irregularly shaped container. The protective covering can be fashioned to conform to the shape of the serving ware. The covering may be loosely or tightly conformed to the shape of the serving ware.

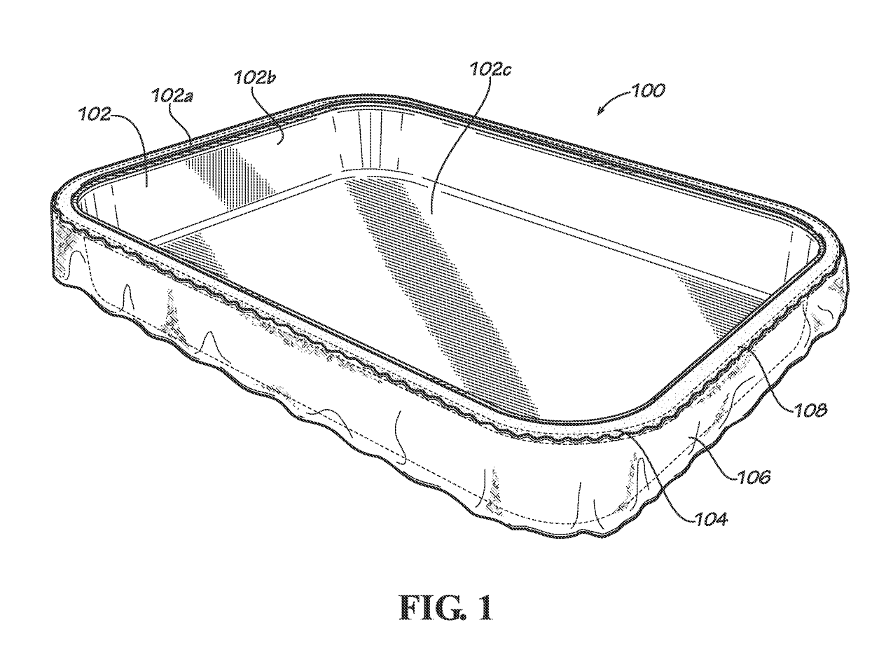

FIG. 1 is a perspective view of a serving ware covering apparatus according to an embodiment. According to an exemplary embodiment, serving ware covering 100 may be selectively disposed around a serving ware 102. Serving ware 102 may be a baking pan, baking sheet, casserole pan, pie pan, and the like. In FIGS. 1-3, serving ware 102 is a rectangular baking dish, but can be any shape including rectangular, oblong, square, round, oval or irregularly shaped. Serving ware 102 may have a flange or upper perimeter 102a, sides 102b, and a base or bottom 102c. Covering 100 may be made from a fabric material, and may have a flange or perimeter portion 104 and a side portion 106. Perimeter portion 104 may be coupled to upper perimeter 102a by the user by stretching covering 100 around upper perimeter 102a and engaging an elastic portion 108. Elastic portion 108 may be sewn or otherwise coupled to an interior of perimeter portion 104. Elastic portion 108 enables the user to stretch covering 100 around any shape serving ware, and the elasticity of elastic portion 108 will enable perimeter portion 204 to “grip” flange 102a. Side portion 106 may be integral to perimeter portion 102 or be sewn or otherwise coupled to perimeter portion 102. Side portion 106 may loosely fit around, or conform to, serving ware 102 such that it covers sides 102b. In this embodiment, a user may remove serving ware 102 from an oven or refrigerator in order to serve its contents for a meal. Prior to placing serving ware 102 on a table for serving, the user may stretch covering 100 around upper perimeter 102a such that sides 102b are covered. Covering 100 thereby provides a thermal barrier for serving ware 102, and/or provides decorative elements to serving ware 102. Covering 100 may include decorative elements such as patterns, colors, and words or markings.

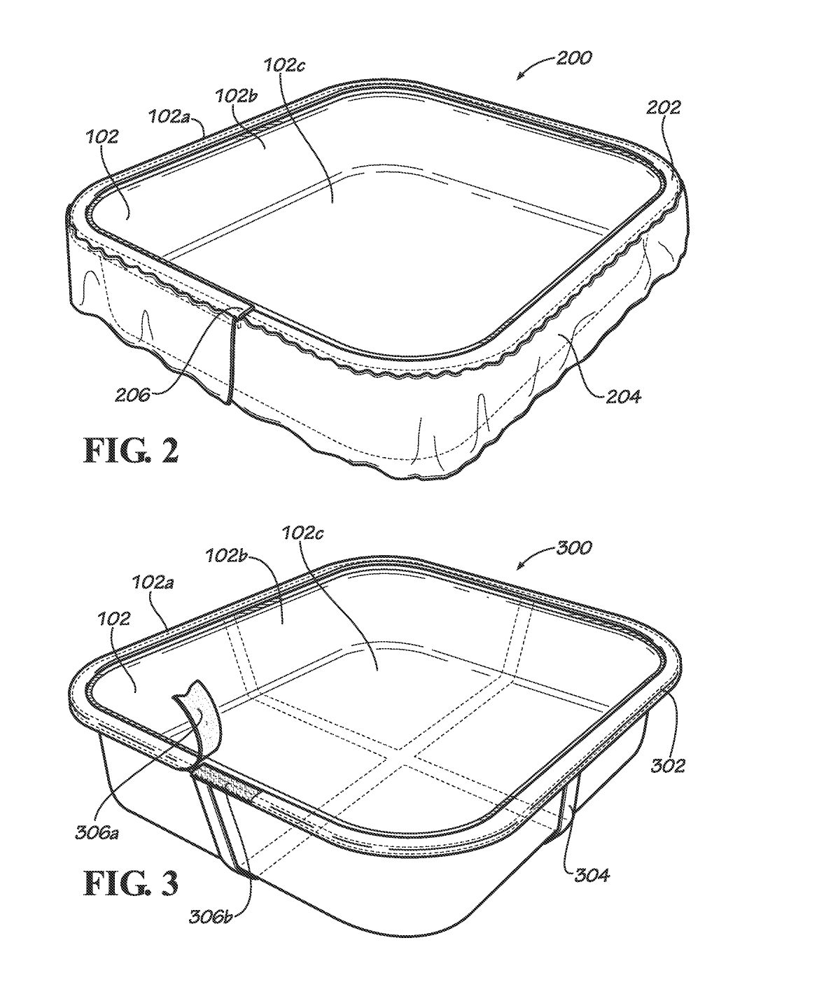

FIG. 2 is a perspective view of a serving ware covering apparatus according to an embodiment. In an exemplary embodiment, serving ware covering 200 is wrapped around a perimeter of serving ware 102. As in FIG. 1, covering 200 may be made from a fabric material, and may have a flange or perimeter portion 202 and a side portion 204. Covering 200 may be generally comprised of a perimeter portion 202, a side portion 204, and a fastening portion 206. Perimeter portion 202 may be coupled to upper perimeter 102a by wrapping covering 200 around upper perimeter 102a and engaging a fastening portion 206. In an embodiment, fastening portion 206 is a hook and loop fastener, but it is anticipated that any fastener such as ties, snaps, hooks, buttons, magnetic closures, elastic, and the like, is readily substitutable. Fastening portion 206 may be sewn or otherwise coupled to an interior of perimeter portion 202. Fastening portion 206 enables the user to wrap covering 200 around any shape serving ware, and the engagement of fastener portion 206 will enable perimeter portion 202 to “grip” flange 102a. Side portion 204 may be integral to perimeter portion 102 or be sewn or otherwise coupled to perimeter portion 202. Side portion 204 may loosely fit around, or conform to, serving ware 102 such that it covers sides 102b. In this embodiment, a user may remove serving ware 102 from an oven or refrigerator in order to serve its contents for a meal. Prior to placing serving ware 102 on a table for serving, user may wrap covering 200 around upper perimeter 102a such that sides 102b are covered. Covering 200 thereby provides a thermal barrier from serving ware 102, and/or provides decorative elements to serving ware 102. Covering 200 may include decorative elements such as patterns, colors, and words or markings.

FIG. 3 is a perspective view of a serving ware covering apparatus according to an embodiment. In an exemplary embodiment, serving ware covering 300 couples to a perimeter and base portion of serving ware 102. Covering 300 may be generally comprised of a perimeter portion 302, a base portion 304, and a fastening portion 306. Covering portion 300 may be comprised of a thermal insulating material such as cotton batting, silicon, neoprene, and the like. Perimeter portion 302 may be coupled to upper perimeter 102a by the user wrapping covering 300 around upper perimeter 102a and sizably engaging fastening portion 306 by pulling covering 300 snug with the surface of serving ware 102 and engaging a first connector 306a of fastening portion 306 with a second connector portion 306b. In an embodiment, fastening portion 306 is a hook and loop fastener, where 306a is a hook and 306b is a loop. It is anticipated that any fastener such as ties, snaps, hooks, buttons, magnetic closures, elastic, and the like, is readily substitutable. Fastening portion 306 may be sewn or otherwise coupled to a surface of perimeter portion 302. Base portion 304 may be connected at substantially equidistant points to perimeter portion 302. Base portion 304 may extend under sides 102b and bottom 102c such that when serving ware 102 is placed on a surface, base portion 304 forms a barrier between serving ware 102 and the surface. When covering 300 is engaged with serving ware 102, it may serve as a thermal insulator to protect the hands of the user from a hot or cold dish, as well as prevent serving ware 102 from coming in direct contact with the surface of a table or counter.

The present disclosure includes that contained in the appended claims as well as that of the foregoing description. Although this invention has been described in its exemplary forms with a certain degree of particularity, it is understood that the present disclosure of has been made only by way of example and numerous changes in the details of construction and combination and arrangement of parts may be employed without departing from the spirit and scope of the invention.

1. An apparatus comprising:
a material layer, the material layer having a first surface configured to engage with an upper perimeter of a serving ware, and a second surface coupled to the first surface, the second surface extending downward substantially perpendicularly from the first surface; and
a coupling means connected to the material layer and configured to engage the first surface with the upper perimeter of the serving ware.

2. The apparatus of claim 19 wherein the material layer is a fabric selected from the group consisting of cotton, polyester, linen, silk, rayon, satin, canvas, hemp, wool, muslin, acetate, nylon and spandex, and combinations thereof.

3. The apparatus of claim 12 wherein the insulating layer is made from a material selected from the group consisting of cotton, cotton terry, cotton batting, silicone, and neoprene, and combinations thereof.

4. The apparatus of claim 1 wherein the coupling means is selected from the group consisting of ties, Velcro, snaps, hooks, buttons, magnetic closures, and elastic, and combinations thereof.

5. The apparatus of claim 1 wherein the upper perimeter of the serving ware may be a shape selected from the group consisting of rectangular, oblong, square, round, oval, and irregular.

6. An apparatus comprising:
a protective surface selectively disposed upon a serving ware, the protective surface having a first side and a second side, the first side extending from an upper perimeter of the serving ware and extending downward from the upper perimeter and terminating substantially perpendicularly to the upper perimeter of the serving ware, and the second side being in contact with an upper perimeter portion of the serving ware when selectively disposed upon the serving ware; and,
a coupling means connected to the protective surface, the coupling means configured to selectively couple the protective surface to the serving ware.

7. The apparatus of claim 6 wherein the protective surface is made of a material selected from the group consisting of fabric, metal, glass, ceramic, willow, bamboo, copper, stone, tile, jewels, crystals, wood, shells, beads, synthetic, and leather, and combinations thereof.

8. The apparatus of claim 6 wherein the coupling means is selected from the group consisting of ties, Velcro, snaps, hooks, buttons, magnetic closures, and elastic, and combinations thereof.

9. An apparatus comprising:
a temperature insulating surface selectively coupled to a serving ware, the temperature insulating surface having a grip portion and a base portion, the grip portion being selectively coupled to an upper perimeter of the serving ware, and the base portion selectively engaged with a bottom surface and a side surface of the serving ware and coupled to the grip portion; and,
a coupling means connected to the temperature insulating surface, the coupling means configured to selectively couple a first end of the temperature insulating surface to a second end of the temperature insulating surface such that the grip portion and the base portion are sizably connected.

10. The apparatus of claim 9 wherein the temperature insulating surface is made from a material selected from the group consisting of cotton, cotton terry, cotton batting, silicone, and neoprene, and combinations thereof.

11. The apparatus of claim 10 wherein the coupling means is selected from the group consisting of ties, Velcro, snaps, hooks, buttons, magnetic closures, and elastic, and combinations thereof.

12. The apparatus of claim 1 further comprising an insulating layer disposed on the material layer, the insulating layer being disposed on an interior portion of the material layer when engaged to the upper perimeter of the serving ware.

13. The apparatus of claim 1 wherein the second surface extending downward substantially perpendicularly from the first surface is configured to engage with a lower perimeter of the serving ware.

14. The apparatus of claim 2 wherein the fabric comprises a pattern, word or marking.

15. The apparatus of claim 6 wherein the first side extending from an upper perimeter of the serving ware and extending downward from the upper perimeter and terminating substantially perpendicularly to the upper perimeter of the serving ware is configured to engage with a lower perimeter of the serving ware.

16. The apparatus of claim 6 wherein the protective surface comprises a pattern, word or marking.

17. The apparatus of claim 9 wherein the temperature insulating surface is a heat insulating surface or a cold insulating surface.

18. The apparatus of claim 9 wherein the temperature insulating surface comprises a pattern, word or marking.

19. The apparatus of claim 1 wherein the material layer is made of a material selected from the group consisting of fabric, metal, glass, ceramic, willow, bamboo, copper, stone, tile, jewels, crystals, wood, shells, beads, synthetic, and leather, and combinations thereof.
